(19) United States
(12) Patent Application Publication
(10) Pub. No.: US 2024/0391743 A1
(43) Pub. Date: Nov. 28, 2024

(54) PORTABLE RADIO-CONTROLLED DEVICE FOR A MULTIFUNCTIONAL LIFTING VEHICLE

(71) Applicant: Merlo Project S.r.l., Cervasca Cuneo (IT)

(72) Inventor: Felice CONTESSINI, Cervasca Cuneo (IT)

(21) Appl. No.: 18/669,982

(22) Filed: May 21, 2024

(30) Foreign Application Priority Data
May 23, 2023 (IT) 102023000010407

(51) Int. Cl. B66F 9/075; B66F 9/065

(52) U.S. Cl. CPC B66F 9/07581; B66F 9/0655

(57) ABSTRACT

A multifunctional lifting vehicle includes a portable radio-controlled device arranged to control the vehicle from a remote position, wherein the portable radio-controlled device includes a plurality of control elements manually operable by an operator to control relative movements and functions of the vehicle. The portable radio-controlled device includes a control display screen configured and programmed to display a plurality of movements and/or functions of the vehicle corresponding to respective actuations of the control elements of the radio-controlled device.

### FIELD OF THE INVENTION

The present invention relates to a multifunctional lifting vehicle comprising
a base frame,
a lifting assembly including at least one operating arm equipped with a connection section for mounting a tool,
a portable radio-controlled device designed to control the vehicle from a remote position,
wherein the portable radio-controlled device comprises a plurality of control elements which can be operated manually by an operator for driving relative movements and functions of the vehicle.

### DESCRIPTION OF THE PRIOR ART

Lifting vehicles of the above type may be equipped with different types of tools, such as forks, shovels, aerial platforms, etc. During operation, the load applied to the tool located at the end of the telescopic arm can vary widely.

According to a technique now consolidated in the technological sector in question, the lifting vehicle may be advantageously operated remotely using a portable radio-controlled device, designed to control the vehicle from a remote position. The radio control is equipped with a plurality of control elements, such as control levers, joysticks, and/or buttons, to be operated manually to control a plurality of movements and functions of the lifting vehicle.

Currently, in order to guide the user in the correct use of the remote controls, the radio control itself may bear various schematic illustrations on its front, applied for example with silk-screen printing, which show movements and/or functions of the vehicle responding to respective actuations of the control elements. However, this representation is often confusing and not very intuitive, also in relation to the fact of having to prepare different illustrations according to the different operating modes of the multifunctional vehicle.

### OBJECT OF THE INVENTION

The object of the present invention is to propose a multifunctional lifting vehicle and a relative portable radio-controlled device for overcoming the problems indicated above.

One object of the present invention is, therefore, to create a clear and effective display of the movements and functions that can be controlled by the radio-controlled device, according to the different operating modes of the vehicle.

### SUMMARY OF THE INVENTION

According to the present invention, the aforesaid objectives are achieved by a lifting vehicle having the characteristics indicated at the beginning of the present description and characterized in that the portable radio-controlled comprises a command display screen configured and programmed to display a plurality of movements and/or or functions of the vehicle responding to respective actuations of the control elements of the radio control.

Additional characteristics of the invention are indicated in the attached claims, which form an integral part of the disclosure administered herein in relation to the invention.

### BRIEF DESCRIPTION OF THE DRAWINGS

The present invention will now be described in detail with reference to the attached drawings, given purely by way of non-limiting example, wherein:

FIG. 1 is a schematic view of a lifting vehicle according to one embodiment;

FIG. 2 is an enlarged view of an example of a tool connected to the frame of the vehicle illustrated in the previous Figure,

FIG. 3 is a schematic view of a portable radio-controlled device according to an embodiment of the invention; and

FIGS. 4-6 show different operating screens as an example of a command display screen included on the radio-controlled device.

### DETAILED DESCRIPTION OF EMBODIMENTS OF THE INVENTION

In the following description, various specific details are illustrated aimed at a thorough understanding of examples of one or more embodiments. The embodiments may be implemented without one or more of the specific details, or with other methods, components, materials, etc. In other cases, known structures, materials or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure.

The references illustrated here are only for convenience and do not, therefore, delimit the field of protection or the scope of the embodiments.

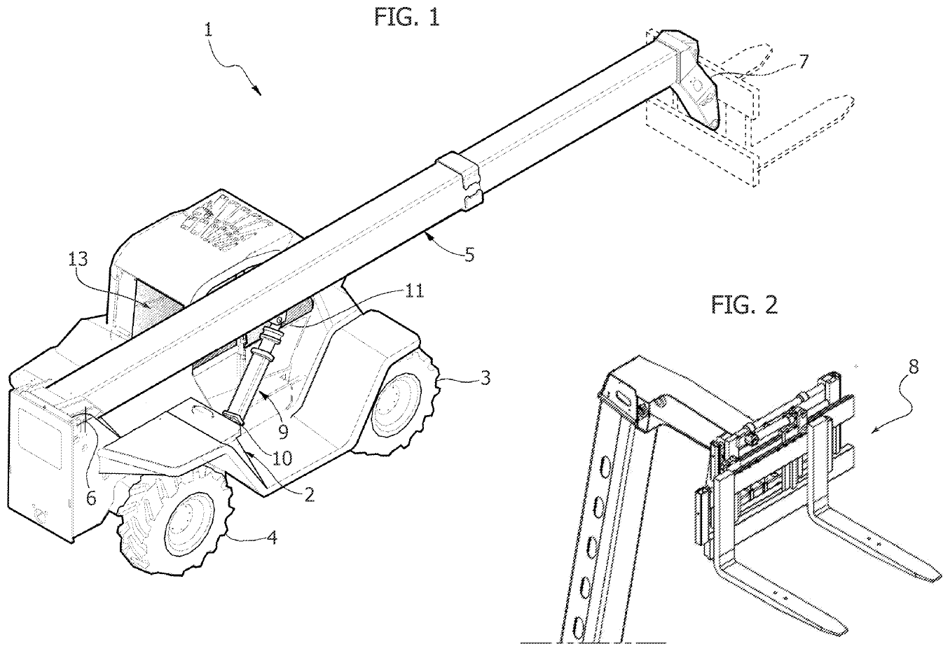

With reference to FIG. 1, numeral 1 indicates a multifunctional lifting vehicle according to the present invention. The vehicle 1 comprises a base frame 2 equipped with front support means 3 and rear support means 4, for example, wheels and/or stabilizers. The base frame 2 may be a fixed, self-propelled or rotating frame.

The vehicle 1 also comprises a lifting assembly 5 having at least one operating arm articulated in the rear section of the frame 2 about a transverse axis 6. The lifting assembly 5 may advantageously comprise a single operating arm or two arms articulated together. One or more of said arms could be telescopic so as to vary their prominence with respect to the base frame 2.

Again with reference to FIG. 1, the actuation assembly 5 is equipped at one of its terminal ends with an attachment 7 for connecting different types of tools 8, such as, for example, forks, shovels, aerial platforms, etc. Purely by way of example, FIG. 2 comprises an example of a tool 8, in particular a forklift connected to a telescopic arm.

The vehicle 1 further comprises a drive system configured to operate the lifting assembly 5 carrying the tool 8. In one or more embodiments, the drive system comprises at least one lifting/lowering cylinder 9 with ends articulated to the frame 2 and to the arm 5 about the respective axes 10, 11.

According to a technique known per se, the lifting vehicle 1 may advantageously be operated remotely using a portable radio-controlled device 12. Therefore, in accordance with what is illustrated in FIG. 1, the portable radio-controlled device 12 is designed to control the vehicle 1 from a different control position compared to a control cab 13 of the vehicle 1. Of course, the present invention is also equally applicable to the case of a vehicle without a control cab, in which case the vehicle will be designed solely to be controlled remotely.

According to a further characteristic, the vehicle 1 is equipped with an electronic control unit configured for receiving control signals transmitted by the radio-controlled device 12, configured for regulating the operation of the vehicle 1 according to the command signals received.

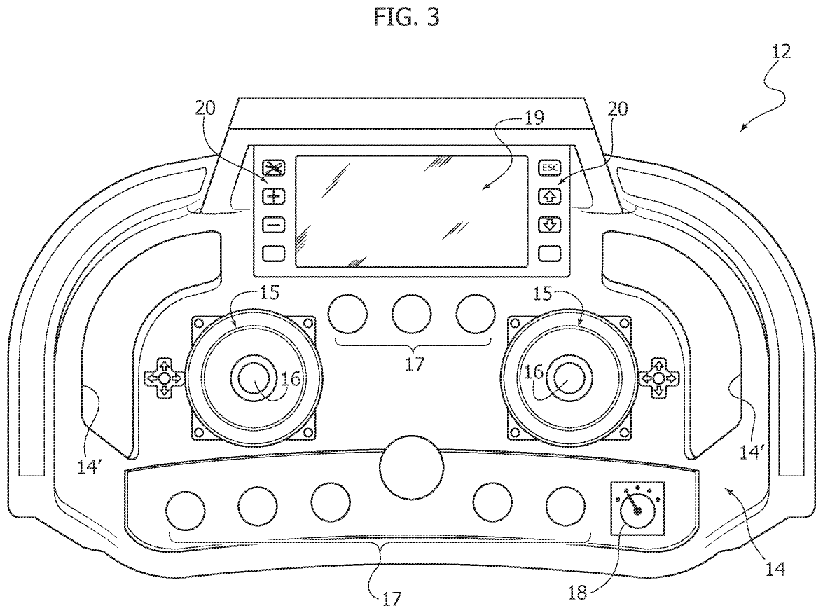

FIG. 3 is a schematic view illustrating a preferred embodiment of a portable radio-controlled device 12 designed to operate the lifting vehicle remotely.

In one or more embodiments, the radio-controlled device 12 comprises an outer casing 14 within which an electronic control card powered by a battery is inserted and a transmitting/receiving section operationally connected to a plurality of control elements that can be operated manually by an operator to control the relative movements and functions of the lifting vehicle 1. In other words, the control elements of the radio control 12 can be selected by the user so as to produce relative control signals that are transmitted to the vehicle 1.

In one or more embodiments, the transmitting/receiving section of the radio control 12 includes a radio frequency transceiver system to exchange signals remotely with the electronic control unit of the vehicle 1. Therefore, the operator can remotely maneuver the vehicle 1, causing, for example, the movement on the ground and/or the activation of the lifting assembly 5 and/or the activation of stabilizer elements associated with the base frame 2. If the tool 8 is an aerial platform, the operator may control the vehicle 1 using the radio control 12 directly from the platform.

According to a preferred characteristic illustrated in FIG. 3, the outer casing 14 comprises a pair of symmetrical handles 14′. Furthermore, in order to allow the operator to operate the control elements without having to hold the radio control 12, the outer casing 14 may comprise a pair of auxiliary openings (not shown) arranged for mutual engagement with a support strap worn by the operator.

In accordance with the embodiment illustrated in FIG. 3, the control elements of the radio control 12 are arranged on a front side of the outer casing 14.

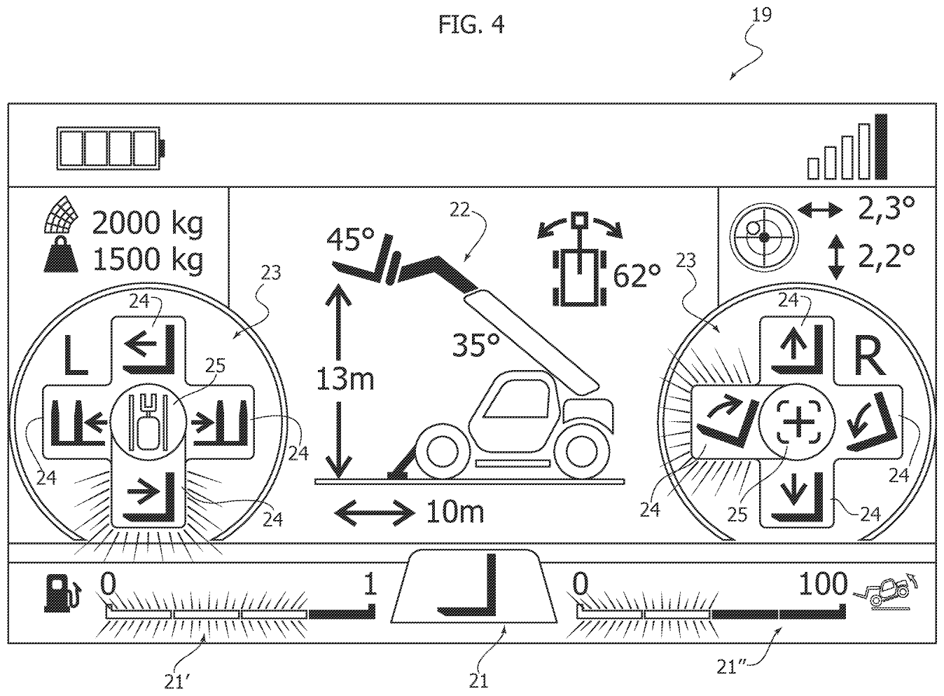

In accordance with the embodiment illustrated in FIG. 4, the control elements of the radio-controlled device 12 may comprise:
two control joysticks 15 arranged on the front side of the radio control 12 in a position of mutual symmetry with respect to a central axis of the radio control,
relevant control buttons 16 located on the top of the joysticks 15,
a plurality of control buttons 17, and
an operating mode selector 18 to select a specific operating mode of the vehicle 1, from those available.

With regard to the aforesaid operating mode selector 18, the multifunctional lifting vehicle 1 may be selectively set according to different operating modes that involve related functions and commands of the vehicle 1, controllable with the radio-controlled device 12, such as for example arm movements, transmission movements, stabilizer movements, lateral and longitudinal leveling movements of the carriage, activation/deactivation and adjustment of the suspension.

In one or more embodiments, the two joysticks 15 are configured to control movements and functions of the vehicle 1, depending on the selected operating mode.

In one or more embodiments, the control buttons 17 are configured to control the switching on of the device 12 and the machine, the selection of appropriate machine settings, the activation and selection of electrical auxiliary components.

According to a characteristic of the invention illustrated in FIG. 3, the portable radio-controlled device 12 also includes a command display screen 19 configured to display a plurality of movements and/or functions of the vehicle 1 responding to respective actuations of the control elements of the radio control.

Preferably, the display screen 19 is positioned at an upper part of the front side of the outer casing 14. Some adjustment keys 20 may be arranged on the sides of the screen 19 to make adjustments to the display screen 19 or to navigate through the available electronic menus. Alternatively, the functions of the adjustment keys 20 may be integrated directly with a touch-screen type display screen 19.

According to one characteristic of the invention, the display screen 19 is also configured and programmed to dynamically display functions and movements of the vehicle responsive to respective control elements, as a function of the selected operating mode and/or the controls of the radio-controlled device that are being operated.

As also described below, the radio-controlled device 12 may be configured and programmed to display on the screen 19 a digital representation of the control elements that are available for use depending on the selected operating mode of the vehicle 1. Therefore, the radio-controlled device 12 may be configured and programmed to exclude the display on the screen 19 of any control elements that cannot be operated due to the operating conditions in which the vehicle is set.

In one or more embodiments, a portion of the screen 19 is constantly dedicated to a digital reproduction of the joysticks 15 and their relative degrees of freedom, so as to show at these portions multiple icons representing vehicle movements and functions which can be controlled by means of the joysticks 15.

In one or more embodiments, each operating mode of the vehicle 1 is associated with a color, imaged on the display screen 19 during the dynamic representation of the available controls. By varying the selection of operating mode using the selector 18, therefore, in addition to varying the dynamic representation of the available controls, the screen is colored in accordance with the identifying color of a specific operating mode.

In one or more embodiments, the control elements of the radio control operated at a given instant are highlighted in this sense on the screen 19, for example, with the display of the same color as the operating mode, so as to constantly signal to the operator the controls currently operated.

In one or more embodiments, a lower portion of the display screen 19 constantly displays an icon identifying the selected operating mode.

Therefore, whatever the selected operating mode of the lifting vehicle 1, the display screen 19 is configured and programmed to provide the operator with a clear indication of:
selected operating mode, recalled on the screen, for example, by the representative icon and/or color;
vehicle movements and/or functions controllable in the set mode and related control elements, without reproducing on the screen any control elements of the radio control that are not permitted due to the operating conditions of the vehicle;
movements and/or functions of the vehicle and relative control elements that are being activated at a given moment.

FIG. 4 shows an operating screen illustrating what was previously described.

This screen refers to a fork mode, which is associated, for example, with a green background and the illustrative icon of this mode (indicated with reference 21). On the sides of the icon 21 are illustrated, respectively, a fuel level indicator 21′ of the vehicle 1 and a scale 21″ configured for indicating the permitted stability index of the machine, variable between 0% machine without load and 100% machine with maximum load allowed.

Again with reference to FIG. 4, a main part 22 of the screen 19 displays a schematic reproduction of the vehicle 1 in the selected mode, and relative operating parameters such as the height from the ground of the tool 8 and the angle of inclination of the telescopic arm with respect to the base frame.

The reference 23 indicates portions of the screen constantly dedicated to the digital display of the joysticks and the relative degrees of freedom. Note that these digital displays correspond to the position of mutual symmetry of the joysticks 15 on the front side of the radio control casing.

The digital reproduction of each joystick 15 comprises four directional keys 24 (forward, backward, right, left) and the central key 25 positioned on the top of the joystick 15. Inside each directional button 24 there are additional icons representing the vehicle functions that can be controlled with the relevant directional button. The directional keys 24 light up consistently with the command given by the operator on the two joysticks 15 (in this case down key for the left joystick (indicated with L—Left) and left key for the right joystick (indicated with R—Right).

As can be seen, in FIG. 4 all the directional keys 24 relative to the two joysticks 15 include a representative icon, given that in the selected mode (fork mode) there are no vehicle movements/functions automatically inhibited.

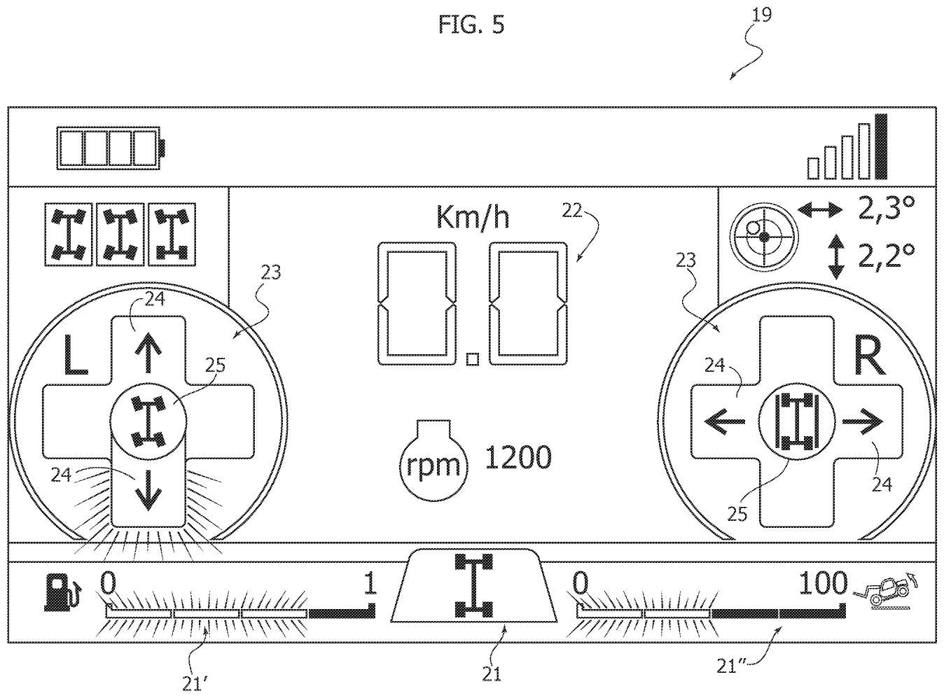

FIG. 5 shows an operating screen relating to a self-propelled mode, which is associated, for example, with a blue background and the illustrative icon of this mode (indicated with reference 21).

As can be seen, the controls associated with the joysticks 15, illustrated in the portions of the screen 23, as well as the color of the screen, have changed compared to what is illustrated in the previous figure relating to a different operating mode of the vehicle 1. In fact, only some directional keys 24 relative to the two joysticks 15 include a representative icon (forward and backward keys for the left joystick and right and left keys for the right joystick). In the screen shown in FIG. 5, the vehicle is currently moving in reverse, the back button on the left joystick being highlighted. Note that the main part 22 of the screen now displays the vehicle speed and engine rpm to give real-time information on the movement of vehicle 1.

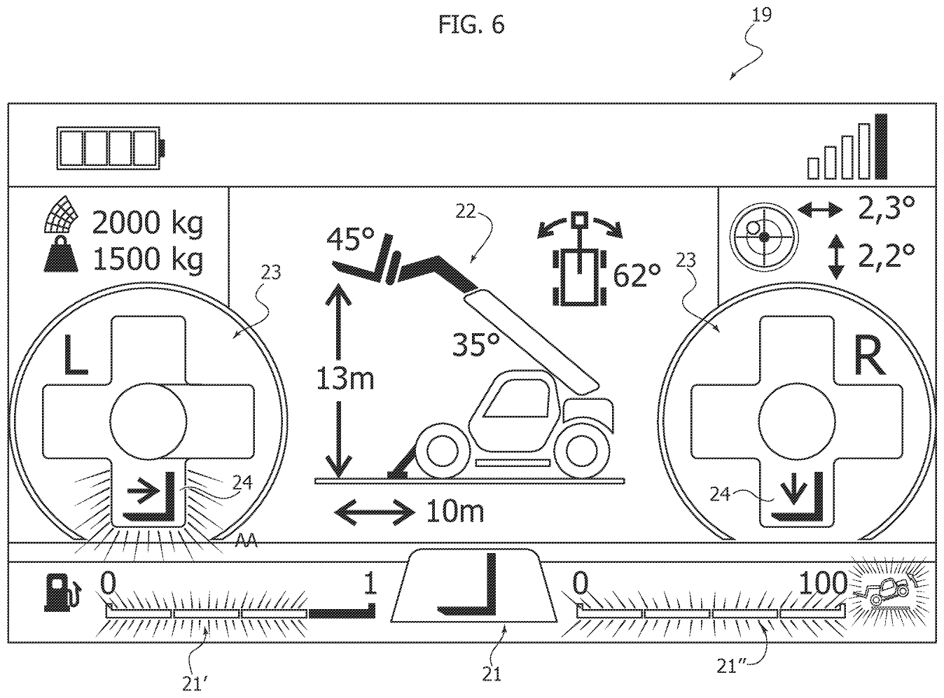

FIG. 6 shows an operating screen relative to reaching the stability limit condition in fork mode, which is associated, for example, with a red background. In this condition, the screen 19 displays only the control keys 24 that allow the vehicle to return to a condition of greater stability (left joystick: back key; right joystick: back key).

In light of the previous description, compared to traditional static displays of the controls of a radio-controlled device for multifunctional lifting vehicles, the present invention makes the following advantages available:
possibility of viewing only the commands available in a specific operating mode,
notable reduction in the space required to illustrate the commands,
easier control of the vehicle using the radio control.

Of course, without prejudice to the principle of the invention as defined in the attached claims, the details of construction and the embodiments may widely vary with respect to those described and illustrated, without thereby departing from the scope of the invention as defined in the claims that follow.

1. A multifunctional lifting vehicle comprising:
a base frame,
a lifting assembly including at least one operating arm equipped with a connection section for mounting a tool, and
a portable radio-controlled device configured for controlling the vehicle from a remote position,
wherein the portable radio-controlled device comprises a plurality of control elements which are configured to be operated manually by an operator for driving relative movements and functions of the vehicle, and
wherein the portable radio-controlled device comprises at least one control display screen configured and programmed to display a plurality of movements and/or functions of the vehicle corresponding to respective actuations of the plurality of control elements of the portable radio-controlled device.

2. The multifunctional lifting vehicle according to claim 1, wherein said portable radio-controlled device comprises an operating mode selector for selecting a specific operating mode of the vehicle, from available operating modes, according to a type of the tool.

3. The multifunctional lifting vehicle according to claim 2, wherein the at least one control display screen is configured and programmed to dynamically display the plurality of movements and/or functions of the vehicle responsive to respective control elements of the portable radio-controlled device, as a function of a selected operating mode and/or the plurality of control elements of the portable radio-controlled device being actuated in real time.

4. The multifunctional lifting vehicle according to claim 3, wherein the portable radio-controlled device is configured and programmed to display on the at least one control display screen a digital representation of certain control elements of said plurality of control elements which are available for use according to the selected operating mode and/or stability conditions of the vehicle, without displaying other control elements of the plurality of control elements that are non-operable due to current operating conditions of the vehicle.

5. The multifunctional lifting vehicle according to claim 1, wherein:
said plurality of control elements comprise at least one joystick,
a portion of the at least one control display screen is constantly dedicated to a digital reproduction of the at least one joystick and its relative degrees of freedom, so as to show at said portion multiple icons representing the plurality of movements and/or functions of the vehicle, which are configured to be controlled by means of the at least one joystick.

6. The multifunctional lifting vehicle according to claim 3, wherein a color is associated with each available operating mode of the vehicle, shown on the at least one control display screen during a dynamic representation of the plurality of control elements available.

7. The multifunctional lifting vehicle according to claim 3, wherein the plurality of control elements of the portable radio-controlled device that are actuated in a given instant are highlighted on the at least one display screen, so as to constantly indicate to the operator the plurality of control elements that are currently actuated.

8. The multifunctional lifting vehicle according to claim 5, wherein the digital reproduction of the at least one joystick comprises directional keys in which respective icons are shown, said icons representing the vehicle functions that are configured to be controlled with a respective directional key.

9. The multifunctional lifting vehicle according to claim 4, wherein, upon reaching a stability limit condition, the portable radio-controlled device is configured and programmed to display only certain control elements of the plurality of control elements that allow the vehicle to return to a condition with increased stability.

10. The multifunctional lifting vehicle according to claim 1, wherein a main part of the at least one control display screen is arranged to display: i) relevant information of the selected operating mode being a fork mode, ii) a schematic representation of the vehicle and related operating parameters including a height from the ground of the tool, and ii) an angle of inclination of the at least one operating arm with respect to the base frame.

11. The multifunctional lifting vehicle according to claim 1, wherein said at least one control display screen is arranged to display in all windows relevant information for operating the portable radio-controlled device and controlling the vehicle, including an amount of fuel contained in a tank of the vehicle, a battery charge of the portable radio-controlled device, an intensity of a transmission signal, a bubble level and a stability percentage of the vehicle.
